(19) United States
(12) Patent Application Publication
(10) Pub. No.: US 2002/0138380 A1
(43) Pub. Date: Sep. 26, 2002

(54) Consolidation, aggregation, and distillation of interactive financial information exchange utilizing online analysts

(76) Inventors: Robert W. Naismith, Scranton, PA (US); Nadia N. Dailey, Clarks Summit, PA (US)

Correspondence Address: Patrick J. Arnold Jr., McAndrews, Held & Malloy, Ltd., 34th Floor, 500 West Madison Street, Chicago, IL, 60661, US

(21) Appl. No.: 10/034,644

(22) Filed: Dec. 28, 2001

Related U.S. Application Data
(60) Provisional application No. 60/259,261, filed on Dec. 28, 2000.

(51) Int. Cl. G06F 17/60

(52) U.S. Cl. 705/35

(57) ABSTRACT

An interactive financial information exchange tool includes a network interface connected to an external network, a processing circuit coupled to the network interface, and a memory coupled to the processing circuit. The memory stores, for execution by the processing circuit, instructions for receiving a query from a remote user over the network interface, presenting the query to an online analyst, accepting an answer to the query from the online analyst, and sending the answer to the remote user over the network interface.

### BACKGROUND OF THE INVENTION

The present invention generally relates to exchange of financial information across a network. In particular, the present invention relates to the exchange of financial information between a remote user and an online analyst.

Accessing financial information and performing financial transactions on the Internet are now commonplace. One benefit of Internet connectivity is that it allows users virtually immediate access to extensive databases and other information collections of financial data. Such information, in the past, was typically known only by a few select individuals.

Searching the financial information collections to find a particular fact was very difficult, however; a user might have to jump from web site to web site, in an attempt to determine whether that site had the required information. Further, even when the user found an appropriate site, the user would still have to distill the vast array of information presented into a usable form.

As a result, today's investor floats aimlessly in the sea of financial information available on the Internet, unable to quickly or accurately find the facts he needs to make an informed investment decision.

A need has long existed in the industry for an interactive financial information exchange tool that addresses the problems noted above and others previously experienced.

### BRIEF SUMMARY OF THE INVENTION

A preferred embodiment of the present invention provides an interactive financial information exchange tool. The tool includes a network interface connected to an external network, a processing circuit coupled to the network interface, and a memory coupled to the processing circuit. The memory stores, for execution by the processing circuit, instructions for receiving a query from a remote user over the network interface, presenting the query to an online analyst, accepting an answer to the query from the online analyst, and sending the answer to the remote user over the network interface.

The memory may further include instructions for opening, at the remote user, an information link selected by the online analyst.

The memory may also store instructions for directing the query first to a hub analyst who selects, at a hub destination, the online analyst to answer the query and then forwards the query to the hub destination.

### BRIEF DESCRIPTION OF THE DRAWINGS

FIG. 1 illustrates an interactive financial information exchange tool connected through an external network to remote terminals.

FIG. 2 shows a flow diagram for providing interactive financial information exchange.

FIG. 3 illustrates interactive financial information exchange windows, including a query feature.

### DETAILED DESCRIPTION OF THE INVENTION

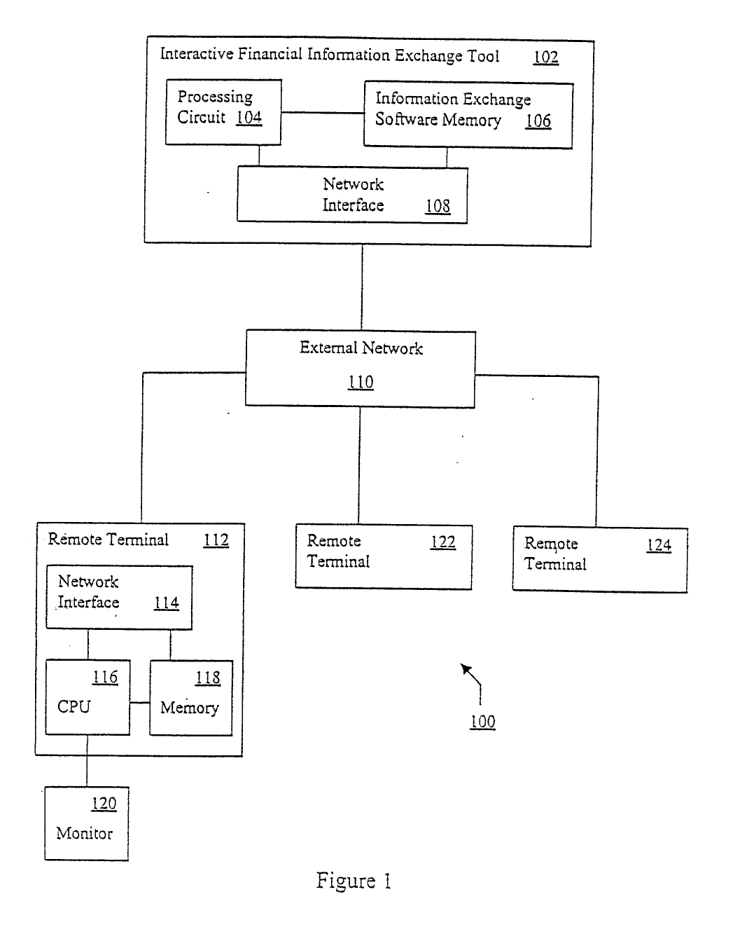

Turning now to FIG. 1, that figure illustrates a network configuration 100, including an interactive financial information exchange tool 102. The interactive financial information exchange tool 102 includes a processing circuit 104 interconnected with an information exchange software memory 106 and a network interface 108. The information exchange software memory 106 is one example of a computer readable storage medium that stores instructions for execution by the processing circuit 104. The computer readable storage medium may be implemented, as examples, using a floppy disk, hard disk, magnetic tape, Read Only Memory (ROM), or Random Access Memory (RAM).

FIG. 1 also illustrates an external network 110 that connects the interactive financial information exchange tool 102 to a remote terminal 112. The remote terminal 112 includes a network interface 114 interconnected with a processing circuit 116 and a general purpose memory 118. The processing circuit 116 is connected to a monitor 120 for viewing output from the remote terminal 112. Additional remote terminals 122 and 124 are also connected through the external network 110 to the interactive financial information exchange tool 102.

The external network 110 may represent, for example, Internet routing and switching functions, or may represent proprietary LAN or WAN networks. The network interfaces 108 and 114 may be implemented, as examples, as network interface cards or modems, and may be hardwired or wireless. The processing circuits 104 and 116 may be general purpose CPUs, such as those in the Pentium™ line of processors. The information exchange software memory 106 stores instructions for execution by the processing circuit 104. The instructions allow the processing circuit 104 to assist remote users with access to financial information using their remote terminals 112, 122, 124.

In the preferred embodiment, the remote terminals 112, 122, 124 represent personal computers connected over the Internet to the interactive financial information exchange tool 102. To that end, the remote terminals 112, 122, 124 execute Internet browsing software, for example, Netscape Navigator™ or Microsoft Internet Explorer™. The interactive financial information exchange tool 102 executes complimentary Internet web server and hosting software, thereby receiving, for example, an initial query from the remote terminals 112, 122, 124, and responsively sending an online analyst's answer, as explained in more detail below.

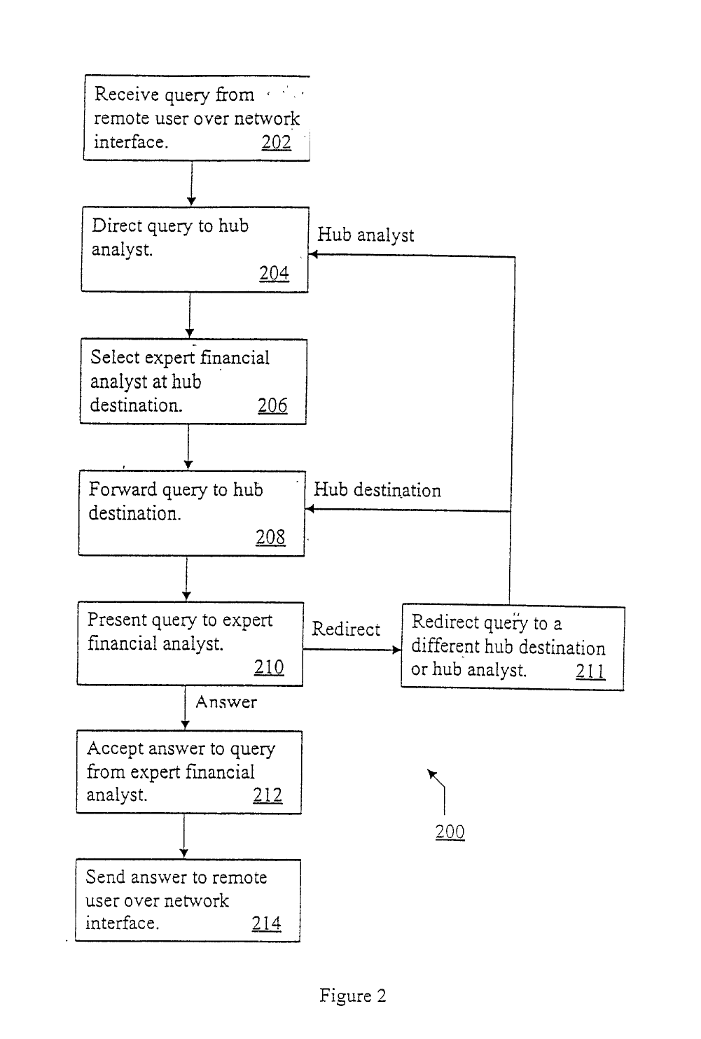

Turning now to FIG. 2, that figure shows a flow diagram 200 of the steps executed by the interactive financial information exchange tool 102 software. At step 202, the interactive financial information exchange tool 102 receives, over the network interface 108 and external network 110, a query from a remote terminal 112, 122, 124. A query preferably includes a request for information from the online analyst. Such a query may seek information regarding, for example, what companies are performing clinical trials on treatments for breast cancer. As another example, a remote user may send a query asking which companies are considering public offerings at a particular time in the future. A query may be a single word, concept, or topic area, such as a company name or a disease name. In such cases, the query is routed to the online analyst most familiar with the concept (e.g., the analyst most familiar with the named company). The queries are not limited to any particular form or subject matter. Rather, they generally present a request (e.g., in text, audio, or visual form) for answers to an online analyst.

Next, at step 204, the processing circuit 104 directs the query to a hub analyst. Then, at step 206, the hub analyst selects an appropriate online analyst at a hub destination. In this step 206, the hub analyst evaluates the query for subject matter and determines a knowledgeable online analyst or group of online analysts to answer the query.

As examples, a group of online analysts—a “hub destination” or “hub”—-may be organized by their expertise: in companies of a particular size (e.g., Small Cap companies with market capitalization under $700 million, Mid Cap companies of $700 million to $2 billion, or Large Cap companies of $2 billion or greater); in companies in a particular financial state (e.g., pre-Initial Public Offering companies, those looking for a merger or acquisition, or those in need of additional financing or distribution); in companies treating particular diseases (e.g., breast cancer, stroke, allergies, or the common cold); or in companies with research or products in particular industries (e.g., genomics, heart valves, pacemakers, catheters, or pharmaceuticals to treat allergies, pain, mental disorders, or heart murmurs). Through their interaction with affinity groups (e.g., biologists, physicians, professional societies, and the like), the online analysts develop relationships as a whole with the affinity groups and professional societies.

Optionally, hubs themselves may be organized within several categories. “Disease hubs” or “industry hubs” (those with expertise in companies specializing in a particular disease or industry, respectively) may be focused within the group of companies which are Small Cap sized and Life Sciences oriented. An industry hub fitting these criteria may, for example, cover companies with under $700 million market capitalization, developing or marketing therapeutic vaccines. With this ability to focus on subspecialties within the broader market, hubs can reach companies which the more traditional investment banking sector may ignore because of their size or the complexity of their technology.

Additionally, each online analyst may possess extensive knowledge of a limited number of companies in a particular field. The online analyst may gather such knowledge through publicly available documentation and information, such as 10-Q and 10-K reports, company web sites, interviews between company management and market analysts, or company conference calls. The online analysts may verify this information, for example, by checking other public filings or by speaking with company officials, such as the investor relations officer. The online analyst may also build relationships with the professionals involved in the online analyst's area of expertise by, for example, joining applicable scholarly societies or attending pertinent trade shows and conventions.

Optionally, the online analyst or group of online analysts may collect the information which they review about a company into a knowledge management system. This may be done while the knowledge management system is online in real time or while the system is offline. The knowledge management system may be searchable by remote users or online analysts via pull-down windows, typed queries, or other known search methods. The fields of information in the knowledge management system may include data corresponding to, for example, the stage of development of a company's research, size of a company, disease being studied by a company, industry focus of a company, industry experience of company management, financial situation of a company, institutional investors backing a company, and other appropriate criteria. An example of a knowledge management system is a database used with software such as Sybase PowerBuilder™ or Microsoft Access™. After aggregating the information for the knowledge management system, the online analysts may distill out those portions of the information most desired by remote users and online analysts. For example, the online analysts may pull together a company's revenue figures for the past five years and make them available through a drop-down menu. Or, the online analysts may take a company's research and development budget and separate it by amounts expended on particular diseases or products being developed for that disease.

Following the determination of the hub destination by the hub analyst, step 208 illustrates that the processing circuit 104 forwards the query to the hub destination. Then, at step 210, the processing circuit 104 presents the query to the online analyst at the hub destination.

Optionally, after any of the preceding steps 202, 204, 206, 208, 210, the tool 102 may place the user's query into a queue, which would maintain the query until a hub analyst or an online analyst was available to address the query by forwarding or answering it. Multiple queries may be queued, as necessary, by time of receipt, topic area, user status, or other ranking criteria.

Another embodiment of the invention provides for the situation in which an online analyst determines that a query or part of a query would be better answered by another online analyst or by one in a different hub destination, especially because companies may have products within multiple therapeutic areas. Additionally, this situation may occur, for example, because the query was initially misrouted, because the remote user's query requires the expertise of multiple online analysts within the same or different hub destination to answer it, or because a user's additional queries require different online analysts' expertise to answer them. In such cases, the online analyst may redirect the query to another online analyst within his or a different hub destination. Alternatively, the online analyst may direct the query back to a hub analyst to determine an appropriate online analyst. These possibilities are illustrated as step 211 in FIG. 2.

Next, at step 212, the processing circuit 104 accepts an answer to the query from the online analyst. The answer may be textual or graphical in nature, or it may be a multimedia hyperlink or other information source. Optionally, a record may be made by the processing circuit 104 of the remote user's query and online analyst's answer to ensure compliance with state and federal regulations, to assist resolution of later remote user disputes, or to monitor quality of online analyst answers. Next, at step 214, the processing circuit 104 sends the answer over the network interface 108 and external network 110 to the remote terminal 112, 122, 124. This answer may be sent in a variety of ways, including an instant messenger service, chat window, web browser service, and the like. Moreover, as noted above, the answer may be in audio form, visual form, or a combination of audio and visual.

Optionally, the online analyst opens an information link at the remote terminal 112, 122, 124. For example, the online analyst could answer a query, which would be sent as in step 214, and open a link for illustrative purposes. In this case, the online analyst may open a link to a pertinent company's web site or an analyst's research report for the remote user's further study. Moreover, the online analyst may open an information link to a group of companies (an “eMedbasket™”), which focus on a particular industry or a particular disease. By presenting companies with a particular focus, an eMedbasket™ assists a remote user in narrowing his research and investment options to only those companies which match his requirements. Furthermore, after researching the companies, a remote user may choose to invest in some or all of them through the eMedbasket™ program. Thus, he may invest generally in companies focused on an industry or disease with less of the risk involved in attempting to pick a “winner” company out of the many involved in that industry or disease.

In opening the information link, as examples, the online analyst and the tool 102 may instruct the web browser on a remote terminal 112, 122, 124 to open a web page, newsgroup, FTP server, or Telnet session in the browser environment or separate from the browser environment. HTML or Java commands may be used for this purpose.

Moreover, opening an information link may be performed across different types of computing environments. As an example, the online analyst could send his answers and information links while sitting at a Sun workstation, as the remote user sends his queries and receives his answers while sitting at a Macintosh remote terminal 112, 122, 124 or a Palm Pilot™ with wireless connections.

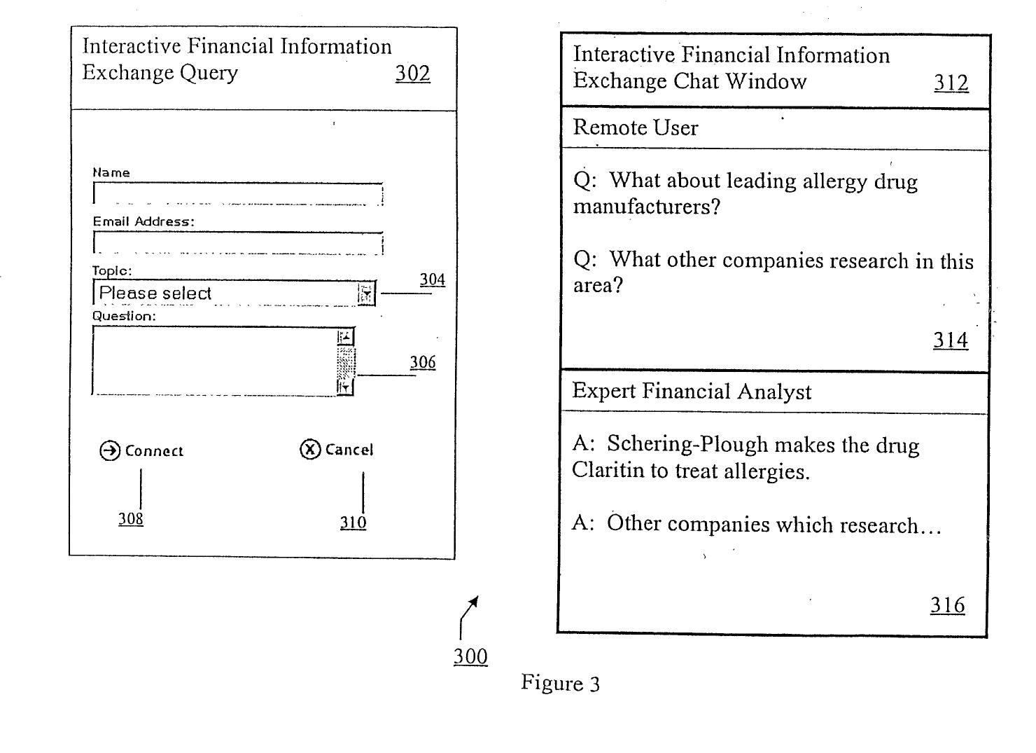

Turning to FIG. 3, that figure shows sample interactive windows 300, including a sample query window 302 and a sample chat window 312. The sample query window 302 includes a topic selection menu 304, a question field 306, a submission button 308, and a cancel button 310. The sample chat window 312 includes a remote user window 314 and an online analyst window 316.

Though the query may be obtained from the remote user in a variety of ways, in the embodiment shown in FIG. 3, the remote user selects a general topic area from the topic selection menu 304, types a query into the question field 306, and submits the query by pressing the submission button 308. Should the remote user make a mistake or not wish to submit a query, he may press the cancel button 310.

Optionally, the topic selection menu 304 of this embodiment may assist the hub analyst in selecting the most appropriate hub or individual online analyst to answer the remote user's query. The topic selection menu 304 may then provide a drop-down list of topic areas, each of which corresponds to a hub or some other arrangement of online analysts.

In the embodiment shown in FIG. 3, after the remote user presses the submit button 308, his remote terminal 112, 122, 124 sends the query through the external network 110 to the interactive financial information exchange tool 102, which presents the query to an online analyst. The remote user and the online analyst then enter a chat mode, shown by the interactive financial information exchange chat window 312, where the online analyst can provide an answer to the remote user's initial query and to any follow-up queries the remote user may have.

Additionally, though the present embodiment speaks generally of an online analyst, the online analyst may be a specialty analyst, such as an expert financial analyst. Such an expert financial analyst may, for example, possess detailed knowledge of companies in a particular industry, performing research on a particular disease, or of a particular size or stage of development.

Thus the present invention provides a flexible and user-friendly interactive financial information exchange tool. The tool handles the enormous variety of queries to which investors need answers in a direct and efficient manner. Investors reap the advantages of access to the vast amounts of financial data available over the Internet but gather only the data they want through the personalized answers of an online analyst alternative to a “bricks and mortar” and heavy investment to build relationships with customers. As a result, the present interactive financial information exchange tool focuses investors on the information they need to make well-informed financial decisions.

While the invention has been described with reference to a preferred embodiment, those skilled in the art will understand that various changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

What is claimed is:

1. An interactive financial information exchange tool comprising:
a network interface connected to an external network;
a processing circuit coupled to the network interface; and
a memory coupled to the processing circuit, the memory storing, for execution by the processing circuit, instructions for:
receiving a query from a remote user over the network interface;
presenting the query to an online analyst;
accepting an answer to the query from the online analyst; and
sending the answer to the remote user over the network interface.

2. The interactive financial information exchange tool of claim 1, further comprising within the memory, instructions for:
opening, at the remote user, an information link selected by the online analyst.

3. The interactive financial information exchange tool of claim 1, further comprising within the memory, instructions for:
directing the query to a hub analyst who selects at a hub destination the online analyst to answer the query; and
forwarding the query to the hub destination.

4. A method for interactive financial information exchange, the method comprising the steps of:
receiving a query from a remote user over a network interface connected to an external network;
presenting the query to an online analyst;
accepting an answer to the query from the online analyst; and
sending the answer to the remote user over the network interface.

5. The method for interactive financial information exchange of claim 4, further comprising the steps of:
opening, at the remote user, an information link selected by the online analyst.

6. The interactive financial information exchange method of claim 4, further comprising the steps of:
directing the query to a hub analyst who selects at a hub destination the online analyst to answer the query; and
forwarding the query to the hub destination.

7. The interactive financial information exchange tool of claim 3, further comprising within the memory instructions for redirecting the query to a further hub destination.

8. The interactive financial information exchange tool of claim 3, further comprising within the memory instructions for redirecting the query to a further hub analyst.

9. The interactive financial information exchange method of claim 6, further comprising the step of redirecting the query to a further hub destination.

10. The interactive financial information exchange method of claim 6, further comprising the step of redirecting the query to a further hub analyst.
